(19) United States
(12) Patent Application Publication
(10) Pub. No.: US 2025/0231144 A1
(43) Pub. Date: Jul. 17, 2025

(54) DEVICE AND METHOD FOR DYNAMIC CRACK DETECTION

(71) Applicant: CHINA OIL & GAS PIPELINE NETWORK CORPORATION, Beijing (CN)

(72) Inventors: Rui LI, Beijing (CN); Kuan FU, Beijing (CN); Pengchao CHEN, Beijing (CN); Yu DING, Beijing (CN); Jianfeng ZHENG, Beijing (CN); Fei PAN, Beijing (CN); Yang LIU, Beijing (CN); Wenbo XUAN, Beijing (CN); Zhengqiang LEI, Beijing (CN); Chao SUN, Beijing (CN)

(73) Assignee: CHINA OIL & GAS PIPELINE NETWORK CORPORATION, Beijing (CN)

(21) Appl. No.: 18/848,940

(22) PCT Filed: Aug. 25, 2023
(86) PCT No.: PCT/CN2023/114822

§ 371 Date: Sep. 20, 2024

(30) Foreign Application Priority Data
Sep. 1, 2022 (CN) 202211068098.5

(51) Int. Cl. G01N 27/90; G01N 27/9013; G01N 27/904

(52) U.S. Cl. CPC G01N 27/9046; G01N 27/9006; G01N 27/902; G01N 27/904

(57) ABSTRACT

A device and a method for dynamic crack detection are provided. The device includes a probe configured to acquire permanent magnetic perturbation (PMP) data and motion-induced eddy current (MIEC) data of an inner surface of a pipe, and a controller, in communication with the probe, configured to: receive the PMP data and the MIEC data from the probe; determine the PMP data and the MIEC data as data of a crack in a case where the PMP data and the MIEC data conform to characteristics of a crack defect signal; and determine characteristic data of the crack based on the MIEC data. The PMP data and MIEC data of the inner surface of the pipe are acquired by a probe, which can detect crack defects in gas pipes under high-speed movement, thus improving the efficiency and stability of dynamic crack detection.

### CROSS REFERENCE TO THE RELATED APPLICATIONS

This application is the national phase entry of International Application No. PCT/CN2023/114822, filed on Aug. 25, 2023, which is based upon and claims priority to Chinese Patent Application No. 202211068098.5, filed on Sep. 1, 2022, the entire contents of which are incorporated herein by reference.

### TECHNICAL FIELD

The present application relates to the field of data processing technology, and specifically to a device and method for dynamic crack detection.

### BACKGROUND

In recent years, pipe failures caused by pipe body and weld cracks have occurred frequently. With the increase of large-diameter high-grade steel pipes in China, the hidden dangers of crack defects are becoming more and more serious. The detection of pipe defects mainly relies on internal inspection of pipes. Internal inspection technologies based on triaxial (ultra) HD magnetic flux leakage, ultrasonic and other principles are mainly adopted at home and abroad, which can effectively detect volumetric defects (corrosion, scratches, etc.) of pipes and defects such as incomplete welding of circumferential welds, excessive grinding, incomplete fusion and incomplete penetration with large openings, and undercut of large sizes. This testing technology is relatively mature and reliable, with the same testing level at home and abroad. Most testing providers have the capability of in-line detection for magnetic flux leakage, which is the main method for current in-line detection of pipes. However, it is difficult to detect planar defects such as cracks by magnetic flux leakage. Ultrasonic testing cannot be used for gas pipes. In addition, there are factors such as high pressure in gas pipes, fast operation speed of internal detector and unstable operation, which further increases the difficulty of detecting pipe crack defects.

### SUMMARY

It is an object of the embodiments of the present application to provide a device and a method for dynamic crack detection to solve the problem of difficulty in detecting crack defects in pipes in the prior art, as follows:
1) In a first aspect, the present disclosure provides a device for dynamic crack detection, with the following specific technical solution:

The device includes a probe configured to acquire permanent magnetic perturbation (PMP) data and motion-induced eddy current (MIEC) data of an inner surface of a pipe, and a controller, in communication with the probe, configured to: receive the PMP data and the MIEC data from the probe; determine the PMP data and the MIEC data as data of a crack in a case where the PMP data and the MIEC data conform to characteristics of a crack defect signal; and determine characteristic data of the crack based on the MIEC data.

The beneficial effects of the device for dynamic crack detection provided by the present disclosure are as follows:
acquiring PMP data and MIEC data of an inner surface of a pipe by the probe, receiving the PMP data and the MIEC data from the probe by the controller, determining the PMP data and the MIEC data as data of a crack in a case where the PMP data and the MIEC data conform to characteristics of a crack defect signal, and determining characteristic data of the crack based on the MIEC data. In this application, the PMP data and MIEC data of the inner surface of the pipe are acquired by a probe, which can detect crack defects in gas pipes under high-speed movement, thus improving the efficiency and stability of dynamic crack detection.

On the basis of the above solution, the device for dynamic crack detection according to the present disclosure can be improved as follows.

Further, the probe includes a sensing module, a signal processing module, and a communication module; the sensing module is configured to acquire the PMP signals and the MIEC signals; the signal processing module, connected to the sensing module, is configured to process the PMP signals and the MIEC signals to obtain the PMP data and the MIEC data; the communication module, connected to the signal processing module, is configured to transmit the PMP data and the MIEC data to the controller.

Further, the sensing module includes a permanent magnet, a magnetic perturbation sensor, and a tri-axis Hall sensor; the permanent magnet is configured to form a magnetic perturbation environment and generate eddy current signals; the magnetic perturbation sensor and the tri-axis Hall sensor are provided on two sides of the permanent magnet, respectively; the magnetic perturbation sensor is configured to collect PMP signals and the tri-axis Hall sensor is configured to collect MIEC signals.

Further, the signal processing module includes an amplifier, a filter, and an analog/digital signal converter;
the amplifier, connected to the magnetic perturbation sensor and the tri-axis Hall sensor, is configured to amplify the PMP signals and the MIEC signals; the filter, connected to the amplifier, is configured to filter out high frequency noise from the amplified PMP signals and the MIEC signals; the analog/digital signal converter, connected to the filter, is configured to convert the denoised PMP signals and the MIEC signals from analog signals to digital signals.

Further, the controller is configured to determine that the PMP data and the MIEC data are data at a crack in a case where the waveform in the X-axis direction of the PMP data presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution.

Further, the controller is further configured to: select a data point in the MIEC data at a preset time interval; for any data point, identify whether the arbitrary data point is a point with the maximum magnetic induction intensity in a first time span; in a case where the arbitrary data point is a point with the maximum magnetic induction intensity in the first time span, store the corresponding time of the data point in a first matrix; in a case where the data point is not a point with the maximum magnetic induction intensity in the first time span if the data point is not the point with the maximum magnetic induction intensity in the first time span, identify whether the average value of the data in a second time span minus the average value of the data in a third time span satisfies the preset value; in a case where the average value of the data in the second time span minus the average value of the data in the third time span satisfies the preset value, store the data point in a second matrix; select a first value of each set of values in the second matrix, and store the first value in a third matrix; and subtract the value in the first matrix and the value in the third matrix, and store the corresponding time of the data point in the second matrix; and subtract the values in the first matrix from the values in the third matrix to obtain characteristic data of the crack.
2) In a second aspect, the present disclosure further provides a method for dynamic crack detection, with the following technical solution:
the method is applied to a controller, the controller is in communication with a probe, and the method includes receiving the PMP data and the MIEC data from the probe; determining the PMP data and the MIEC data as data of a crack in a case where the PMP data and the MIEC data conform to characteristics of a crack defect signal; determining characteristic data of the crack based on the MIEC data.

On the basis of the above solution, a method for dynamic crack detection according to the present disclosure can be improved as follows.

Further, determining the PMP data and the MIEC data as data of a crack in a case where the PMP data and the MIEC data conform to characteristics of a crack defect signal includes:
determining that the PMP data and the MIEC data are data at a crack in a case where the waveform in the X-axis direction of the PMP data presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution.

Further, determining the characteristic data of the crack based on the MIEC data includes selecting data points in the MIEC data at preset time intervals; for an arbitrary data point, identifying whether the arbitrary data point is a point of maximum magnetic induction intensity in a first time span; storing the corresponding time of the data point in a first matrix in a case where the arbitrary data point is a point of maximum magnetic induction intensity in the first time span; identifying whether the average value of the data in a second time span minus the average value of the data in a third time span satisfies a preset value in a case where the data point is not the point of maximum magnetic induction intensity in the first time span; storing the data point in a second matrix in a case where the average value of the data in the second time span minus the average value of the data in the third time span satisfies a preset value; selecting a first value in each set of values in the second matrix and storing the first value in a third matrix; and subtracting the values in the first matrix from the values in the third matrix to obtain characteristic data of the crack.
3) In a third aspect, the present disclosure further provides a method for dynamic crack detection, with the following technical solution:
receiving PMP data and MIEC data of an inner surface of a pipe collected by a probe;
determining the PMP data and the MIEC data as data of a crack in a case where the PMP data and the MIEC data conform to characteristics of a crack defect signal; and
determining characteristic data of the crack based on the MIEC data.
4) In a fourth aspect, the present disclosure further provides a method for data acquisition, with the following technical solution:
the method is applied to a probe; the probe is in communication with a controller, including a sensing module, a signal processing module and a communication module; the signal processing module is connected to the sensing module and the communication module is connected to the signal processing module; the method includes: acquiring PMP signals and MIEC signals by the sensing module;
   processing the PMP signals and the MIEC signals by the signal processing module to obtain the PMP data and the MIEC data; and transmitting the PMP data and the MIEC data to the controller by the communication module.

On the basis of the above solution, a method for data acquisition according to the present disclosure can be further improved as follows.

Further, the sensing module includes a permanent magnet, a magnetic perturbation sensor and a tri-axis Hall sensor; the magnetic perturbation sensor is set on a first side of the permanent magnet and the tri-axis Hall sensor is set on a second side of the permanent magnet; the method includes forming a magnetic perturbation environment and generating eddy current signals by the permanent magnet; collecting PMP signals by the magnetic perturbation sensor; and collecting MIEC signals by the tri-axis Hall sensor.

Further, the signal processing module includes an amplifier, a filter, an analog/digital signal converter; the amplifier is connected to the magnetic perturbation sensor and the tri-axis Hall sensor, the filter is connected to the amplifier, and the analog/digital signal converter is connected to the filter; the method includes amplifying the PMP signals and the MIEC signals by the amplifier; filtering high-frequency noise in the amplified PMP signals and the MIEC signals by the filter; and converting the denoised PMP signals and the MIEC signals from analog signals to digital signals by the analog/digital signal converter. It should be noted that the beneficial effects achieved by the technical solutions of the second aspect to the fourth aspect of the present disclosure and the corresponding possible ways of realizing them can be found in the technical effects described above for the first aspect and its corresponding possible ways of realizing it, and will not be repeated here.

### BRIEF DESCRIPTION OF THE DRAWINGS

The drawings are used to provide a further understanding of the embodiments of this application and form part of the specification. They are used to explain the embodiments of this application together with the following detailed embodiments, but do not constitute a limitation on the embodiments of this application. In the drawings:

FIG. 1 schematically illustrates a diagram of a device for dynamic crack detection according to embodiments of the present application;

FIG. 2 schematically illustrates a structural view of a probe according to embodiments of the present application;

FIG. 3 schematically illustrates a detailed compositional view of the interior of a probe according to embodiments of the present application;

FIG. 4 schematically illustrates plots of crack detection signals of a probe according to embodiments of the present application;

FIG. 5 schematically illustrates a flowchart of a method for dynamic crack detection according to embodiments of the present application;

FIGS. 6A-6B schematically illustrate plots of crack detection signals at different speeds according to embodiments of the present application; FIG. 6A shows one of the plots of crack detection signals for the change in magnetic induction of a permanent magnet for a same crack at speeds of 1 m/s, 5 m/s and 10 m/s, and FIG. 6B shows another of the plots of crack detection signals for the change in magnetic induction of a permanent magnet for the same crack at speeds of 1 m/s, 5 m/s and 10 m/s;

FIGS. 7A-7B schematically illustrate plots of crack detection signals with different widths according to embodiments of the present application; FIG. 7A shows one of the plots of crack detection signals with a crack width of 0.1 mm, 0.4 mm, and 0.9 mm, respectively; and FIG. 7B shows another of the plots of crack detection signals with a crack width of 0.1 mm, 0.4 mm, and 0.9 mm, respectively.

FIGS. 8A-8B schematically illustrate plots of crack detection signals with different depths according to embodiments of the present application, FIG. 8A shows plots of crack detection signals with a crack depth of 4 mm, 5 mm and 10 mm, respectively; and FIG. 8B shows plots of crack detection signals a crack depth of 4 mm, 6 mm and 10 mm.

FIG. 9 schematically illustrates a flowchart extracted from characteristic data of a crack according to embodiments of the present application;

FIG. 10 schematically illustrates a flowchart of a method for data acquisition according to embodiments of the present application.

In the drawings, the parts represented by reference numbers are listed below:
110, sensing module; 120, signal processing module; 130, communication module; 111, permanent magnet; 112, magnetic perturbation sensor; 113, magnetic sensor; 121, amplifier; 122, filter; and 123, analog/digital converter.

### DETAILED DESCRIPTION OF THE EMBODIMENTS

In order to make the purpose, technical solutions and advantages of the embodiments of this application more clear, the technical solutions in the embodiments of this application will be clearly and completely described below with reference to the drawings in the embodiments of this application. It should be understood that the detailed description of the preferred embodiments described herein are only for illustrating, explaining and not for limiting the embodiments of this application. Based on the embodiments in this application, all other embodiments obtained by a person of ordinary skill in the art without making creative labor fall within the scope of protection of this application.

It should be noted that if the embodiments of the present application involve directional indications (such as up, down, left, right, forward, back . . . ), such directional indications are only used to explain the relative positional relationship, movement, etc., between the components in a particular attitude (as shown in the attached drawings), and if the particular attitude is changed, the directional indication will be changed accordingly.

Furthermore, if the embodiments of the present application contain descriptions involving “first”, “second”, etc., the descriptions of “first”, “second”, etc. are used only for descriptive purposes and are not to be construed as indicating or implying their relative importance or implicitly specifying the number of technical features indicated. Thus, the features defined with the terms “first” and “second” may explicitly or implicitly include at least one of these features. Furthermore, the technical solutions between embodiments may be combined with each other, but it must be based on the fact that the person of ordinary skill in the art is able to realize it, and when the combination of the technical solutions appears to be contradictory or unattainable it should be considered that the combination of such technical solutions does not exist, and is not in the scope of protection claimed in this application.

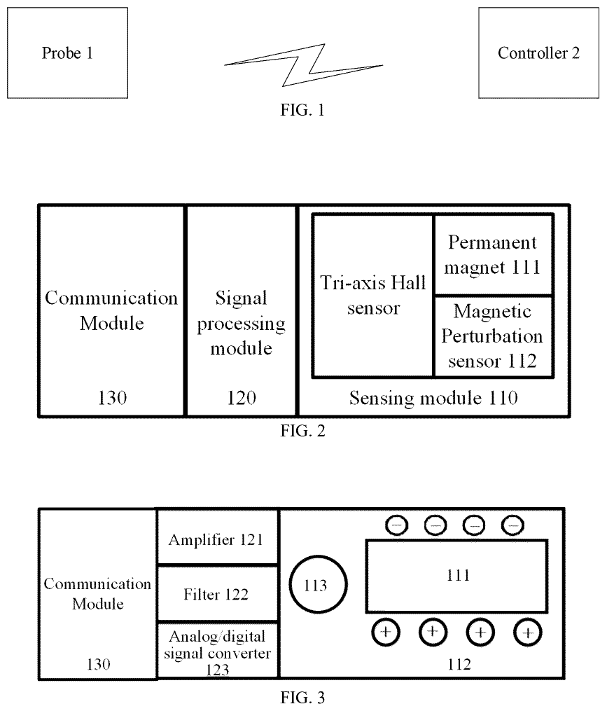

FIG. 1 schematically illustrates a diagram of a device for dynamic crack detection according to embodiments of the present application. As shown in FIG. 1, embodiments of the present application provides a device for dynamic crack detection, which may include: a probe 1 configured to acquire permanent magnetic perturbation (PMP) data and motion-induced eddy current (MIEC) data of an inner surface of a pipe, and a controller 2, in communication with the probe, configured to: receive the PMP data and the MIEC data from the probe; determine the PMP data and the MIEC data as data of a crack in a case where the PMP data and the MIEC data conform to characteristics of a crack defect signal; and determine characteristic data of the crack based on the MIEC data.

In the prior art, the detection of pipe defects mainly relies on internal inspection of pipes. Internal inspection technologies based on triaxial (ultra) HD magnetic flux leakage, ultrasonic and other principles are mainly adopted at home and abroad, which can effectively detect volumetric defects (corrosion, scratches, etc.) of pipes and defects such as incomplete welding of circumferential welds, excessive grinding, incomplete fusion and incomplete penetration with large openings, and undercut of large sizes. This testing technology is relatively mature and reliable, with the same testing level at home and abroad. Most testing providers have the capability of in-line detection for magnetic flux leakage, which is the main method for current in-line detection of pipes. However, it is difficult to detect planar defects such as cracks by magnetic flux leakage. Ultrasonic testing cannot be used for gas pipes. In addition, there are factors such as high pressure in gas pipes, fast operation speed of internal detector and unstable operation, which further increases the difficulty of detecting pipe crack defects. Therefore, embodiments of the present application propose a composite dynamic crack detection probe and method for detecting pipe cracks under high-speed movement.

In embodiments of the present application, the probe 1 is mobile during the inspection process, the probe 1 is mounted on an inner detector, the inner detector travels through the pipe, If the pipe has cracks on the wall, and the probe 1, as it passes over the cracks, collects PMP data and MIEC data from the cracks as a means of detecting and quantifying the crack defects in an overall manner. The controller 2 is communicatively connected to the probe 1, and the controller 2 may receive PMP data and MIEC data sent by the probe 1. After the controller 2 receives the PMP data and the MIEC data sent by the probe 1, it first determines whether the received PMP data and the MIEC data satisfy the signal characteristics of the crack defect, and in the case where the PMP data and the MIEC data satisfy the signal characteristics of the crack defect, it determines that the PMP data and the MIEC data are data of the crack. Finally, the characteristic data of the crack is determined by analyzing the received MIEC data.

According to the above technical solution, a device for dynamic crack detection is provided, which includes a probe and a controller. The controller communicates with the probe, acquiring PMP data and MIEC data of an inner surface of a pipe by the probe, receiving the PMP data and the MIEC data from the probe by the controller, determining the PMP data and the MIEC data as data of the crack in a case where the PMP data and the MIEC data conform to characteristics of a crack defect signal, and determining characteristic data of the crack based on the MIEC data. In this application, the PMP data and MIEC data of the inner surface of the pipe are acquired by a probe, which can detect crack defects in gas pipes under high-speed movement, thus improving the efficiency and stability of dynamic crack detection.

FIG. 2 schematically illustrates a structural view of a probe according to embodiments of the present application. As shown in FIG. 2, in embodiments of the present application, the probe may include: a sensing module 110 configured to acquire the PMP signals and the MIEC signals; and a signal processing module 120, connected to the sensing module 110, configured to process the PMP signals and the MIEC signals to obtain the PMP data and the MIEC data;
a communication module 130, connected to the signal processing module 120, configured to transmit the PMP data and the MIEC data to the controller.

In embodiments of the present application, the probe includes a sensing module 110, a signal processing module 120 and a communication module 130. The sensing module 110 is provided at the rightmost side of the probe for acquiring the PMP signals and the MIEC signals generated by the movement of the probe relative to the pipe, and the signal processing module 120 is provided at the middle of the probe, connected to the sensing module 110 for processing the PMP signals and the MIEC signals to obtain the PMP data and the MIEC data. The communication module 130 is connected to the signal processing module 120, and the communication module 130 is located at the leftmost side of the probe for sending the PMP data and the MIEC data to the controller.

FIG. 3 schematically illustrates a detailed compositional view of the interior of a probe according to embodiments of the present application. As shown in FIGS. 2 and 3, in embodiments of the present application, the sensing module 120 may include:
a permanent magnet 111 configured to form a magnetic perturbation environment and generate eddy current signals, a magnetic perturbation sensor 112 provided at a first side of the permanent magnet 111 and configured to collect PMP signals, and a three-axis Hall sensor 113 provided at a second side of the permanent magnet 111 and configured to collect MIEC signals.

In embodiments of the present application, it is assumed that the first side is downward and the second side is leftward. The sensing module 120 includes three parts: a permanent magnet 111, a magnetic perturbation sensor 112, and a tri-axis Hall sensor 113. The permanent magnet 111 is located in the upper right position of the probe, and the magnetic perturbation sensor 112 is located below the permanent magnet 111 for collecting and measuring the magnetic perturbation signal changes generated by the movement of the permanent magnet 111 relative to the pipe. When the permanent magnet 111 is placed close to the surface of the pipe, magnetic interaction occurs, creating a magnetic perturbation environment, and crack defects on the inner surface of the pipe act as a source of perturbation, which then forms a magnetic perturbation and is observed. The tri-axis Hall sensor 113 is located to the left of the permanent magnet 111, and the permanent magnet 111 moves relative to the pipe wall during the detection process to generate eddy current signals, and the eddy current signals generate abnormal signals at the cracks on the inner surface of the pipe, and the tri-axis Hall sensor 113 is used to measure the abnormal signals generated by the MIEC at the cracks in the inner wall of the pipe, i.e., the MIEC signals. The first side of the permanent magnet 111 is a magnetic perturbation sensor 112 and the second side is a tri-axis Hall sensor 113. The magnet 111 and the magnetic perturbation sensor 112 may form a PMP detection module, and the permanent magnet 111 and the tri-axis Hall sensor 113 may form an MIEC detection module. The PMP detection module can detect the PMP signals of crack defects in the inner wall of the pipe, and the MIEC detection module can detect the abnormal signals generated by the MIEC at the cracks in the inner wall of the pipe.

In one example, the permanent magnet 111 and the magnetic perturbation sensor 112 may form a PMP detection module. The permanent magnet 111 can be a rectangular shaped magnet, and below it are four magnetic perturbation sensors 112 arranged in parallel for measuring the PMP signals of the crack defects in the inner wall of the pipe, and placing the four sensors can differentially amplify the signals to improve the quality of the defect signal detection, and the magnetic interaction will be generated when the permanent magnet 111 is close to the pipe wall, and when discontinuous mutation occurs in the pipe wall, the constructed magnetic interaction field will have a magnetic perturbation generated and fed back to the permanent magnet 111, causing changes in the magnetic field within the permanent magnet 111. When no defects appear, no magnetic perturbation occurs, when it begins to approach the defects, the magnetic perturbation begins to be generated and increases with the increase in the range of the defects, when the permanent magnet 111 is located directly above the defects, the magnetic perturbation is the largest, with the permanent magnet 111 sweeping away from the defects, the magnetic perturbation is gradually reduced, until it disappears, and then returns to the initial no-defect signal. Until it disappears, and then returns to the initial defect-free state, and the magnetic perturbation changes caused by the defects can be detected by the magnetic perturbation sensor 112. The permanent magnet 111 and the tri-axis Hall sensor 113 may form an MIEC detection module for measuring abnormal signals generated by the MIEC at the cracks in the inner wall of the pipe.

As shown in FIGS. 2 and 3, in embodiments of the present application, the signal processing module 120 may include: an amplifier 121, connected to the magnetic perturbation sensor 112 and the tri-axis Hall sensor 113 and configured to amplify the PMP signals and the MIEC signals; a filter 122, connected to the amplifier 121 and configured to filter out high frequency noise from the amplified PMP signals and the MIEC signals, and an analog/digital signal converter 123, connected to the filter 122 and configured to convert the denoised PMP signals and the MIEC signals from analog signals to digital signals.

In embodiments of the present application, the signal processor 120 module is located in the middle of the probe and is connected to the sensing module 110 and the communication module 130, respectively. The signal processing module 120 includes an amplifier 121, a filter 122, and an analog/digital signal converter 123, and the amplifier 121 is connected to the magnetic perturbation sensor 112 and the tri-axis Hall sensor 113, accepting the PMP signals detected by the magnetic perturbation sensor 112 and the MIEC signals detected by the tri-axis Hall sensor 113. The amplifier 121 filters out the spurious signals from the voltage signals and amplifies the signals by a certain multiple, and the amplified signals are more conducive to reading and processing later signals. The filter 122 is connected to the amplifier 121 to receive the detection signal amplified by the amplifier 121, and the filter 122 is a low-pass filter provided between the amplifier 121 and the analog/digital signal converter 123 for performing a filtering operation on the amplified detection signal, filtering out high-frequency noise in the detection signal, and then transmitting the detection signal with the high-frequency noise eliminated to the analog/digital signal converter 123. The analog/digital signal converter 123 is connected to the filter 122 to receive the filtered detection signal, and the analog/digital signal converter 123 converts the denoised analog signals to digital signals and outputs the digital signals after conversion as a result.

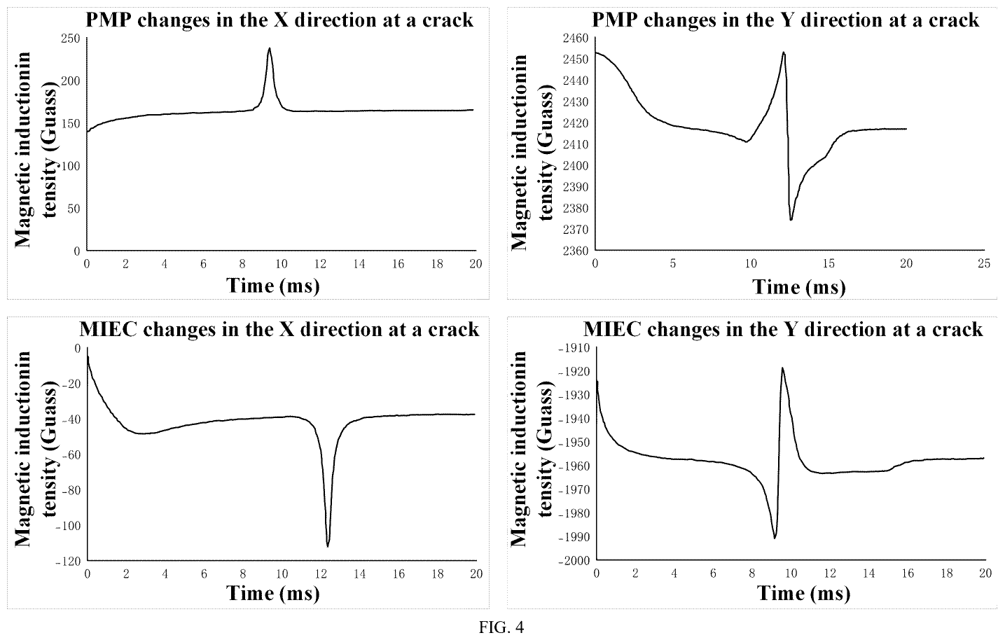

FIG. 4 schematically illustrates plots of crack detection signals of a probe according to embodiments of the present application. As shown in FIG. 4, in embodiments of the present application. the controller may be further configured to determine that the PMP data and the MIEC data are data at a crack in a case where the waveform in the X-axis direction of the PMP data presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution.

In embodiments of the present application, when the permanent magnet is close to the pipe, a constant magnetic field b will be generated on the inner surface of the pipe, and when the permanent magnet and the surface of the pipe are in a relative movement, according to Faraday's Laws of Electromagnetic Induction, the surface of the specimen, i.e., the surface of the pipe wall, will generate MIECs, denoted by C1 and C2, and according to Lenz's Law, the directions of C1 and C2 are opposite, and the C1 and C2 will generate a secondary magnetic field b1 and b2, respectively, where the direction of b1 is the same as that of the constant magnetic field b, and the direction of b2 is opposite to that of the constant magnetic field b. At the same time the pipe will be magnetized by the constant magnetic field b, producing a magnetizing field b3. The direction of b3 is the same as the direction of the constant magnetic field b, so an integrated magnetic field B is equal to b+b1+b2+b3. As the probe passes over the surface of a pipe with crack defects, the integrated magnetic field changes, and the changes in the integrated magnetic field generated by passing over the crack defects can be detected by a tri-axis Hall sensor. The controller determines that the PMP data and the MIEC data are data at a crack in a case where the waveform in the X-axis direction of the PMP data received by the controller presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution.

In embodiments of the present application, the controller may be further configured to: select data points in the MIEC data at preset time intervals; for an arbitrary data point, identify whether the arbitrary data point is a point of maximum magnetic induction intensity in a first time span; store the corresponding time of the data point in a first matrix in a case where the arbitrary data point is a point of maximum magnetic induction intensity in the first time span; identify whether the average value of the data in a second time span minus the average value of the data in a third time span satisfies a preset value in a case where the data point is not the point of maximum magnetic induction intensity in the first time span; store the data point in a second matrix in a case where the average value of the data in the second time span minus the average value of the data in the third time span satisfies a preset value; select a first value in each set of values in the second matrix and store the first value in a third matrix; and subtract the values in the first matrix from the values in the third matrix to obtain characteristic data of the crack.

In embodiments of the present application, after the controller receives the PMP data and the MIEC data sent by the probe, the characteristic data of the crack in the MIEC data, i.e., the peak arrival time in the X-axis data, is extracted. The controller first selects the data points in the MIEC data at a preset time interval starting from a first data point of a data segment, wherein the preset time interval may be set according to the actual situation. For an arbitrary data point, identify whether the arbitrary data point is a point of maximum magnetic induction intensity in a first time span, that is, 500 ms before and after the data point. Store the corresponding time of the data point in a first matrix, i.e., matrix A, in a case where the arbitrary data point is a point of maximum magnetic induction intensity in the first time span. Identify whether the average value of the data in a second time span, that is, from 10 ms before the data point to 30 ms after the data point, minus the average value of the data in a third time span, that is, from 20 ms before the data point to 20 ms after the data point, satisfies a preset value in a case where the data point is not the point of maximum magnetic induction intensity in the first time span. Store the data point in a second matrix, i.e., matrix B, in a case where the average value of the data in the second time span minus the average value of the data in the third time span satisfies a preset value, wherein the preset value is a value greater than 0.2 and less than 0.3. Select a first value in each set of values in the second matrix and store the first value in a third matrix, i.e. matrix C. Subtract the values in the first matrix from the values in the third matrix to obtain characteristic data of the crack, i.e. the peak arrival time.

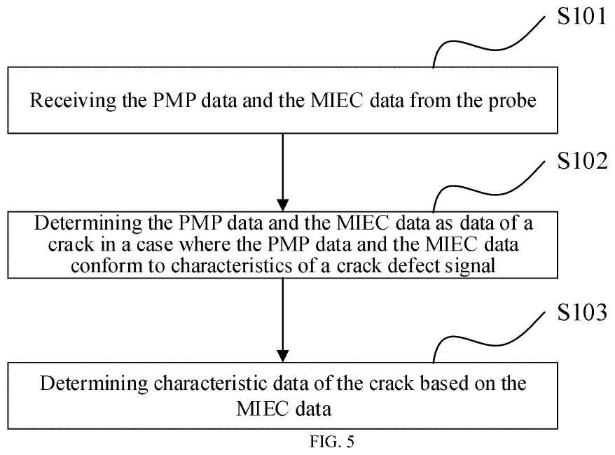

FIG. 5 schematically illustrates a flowchart of a method for dynamic crack detection according to embodiments of the present application. As shown in FIG. 5, embodiments of the present application provide a flowchart of a method for dynamic crack detection, applied to a controller, which communicates with a probe, and the method may include the following steps:
S101, receiving the PMP data and the MIEC data from the probe;
S102, determining the PMP data and the MIEC data as data of a crack in a case where the PMP data and the MIEC data conform to characteristics of a crack defect signal; and
S103, determining characteristic data of the crack based on the MIEC data.

In embodiments of the present application, the probe is mobile during the inspection process, the probe is mounted on an inner detector, the inner detector travels through the pipe, If the pipe has cracks on the wall, and the probe, as it passes over the cracks, collects PMP data and MIEC data from the cracks as a means of detecting and quantifying the crack defects in an overall manner. The controller is communicatively connected to the probe, and the controller may receive PMP data and MIEC data sent by the probe. After the controller receives the PMP data and the MIEC data sent by the probe, it first determines whether the received PMP data and the MIEC data satisfy the signal characteristics of the crack defect, and in the case where the PMP data and the MIEC data satisfy the signal characteristics of the crack defect, it determines that the PMP data and the MIEC data are data of the crack. Finally, the characteristic data of the crack is determined by analyzing the received MIEC data.

As shown in FIG. 4, in embodiments of the present application, in a case where the PMP data and the MIEC data conform to characteristics of a crack defect signal, determining that the PMP data and the MIEC data are the data at the crack may include: determining the PMP data and the MIEC data as data of the crack in a case where the waveform in the X-axis direction of the PMP data presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution.

In embodiments of the present application, when the permanent magnet is close to the pipe, a constant magnetic field b will be generated on the inner surface of the pipe, and when the permanent magnet and the surface of the pipe are in a relative movement, according to Faraday's Laws of Electromagnetic Induction, the surface of the specimen, i.e., the surface of the pipe wall, will generate MIECs, denoted by C1 and C2, and according to Lenz's Law, the directions of C1 and C2 are opposite, and the C1 and C2 will generate a secondary magnetic field b1 and b2, respectively, where the direction of b1 is the same as that of the constant magnetic field b, and the direction of b2 is opposite to that of the constant magnetic field b. At the same time the pipe will be magnetized by the constant magnetic field b, producing a magnetizing field b3. The direction of b3 is the same as the direction of the constant magnetic field b, so an integrated magnetic field B is equal to b+b1+b2+b3. As the probe passes over the surface of a pipe with crack defects, the integrated magnetic field changes, and the changes in the integrated magnetic field generated by passing over the crack defects can be detected by a tri-axis Hall sensor. The controller determines that the PMP data and the MIEC data are data at a crack in a case where the waveform in the X-axis direction of the PMP data received by the controller presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution. Based on the characteristics of the two sensors detecting crack signals in the composite dynamic crack detection probe, the crack defect signal characteristics can be identified. In one example, for the magnetic perturbation sensor, the signal waveform in the X-axis direction presents an upward unimodal distribution, and the signal waveform in the Y-axis direction presents an up-down bimodal distribution; and for the tri-axis Hall sensor, the signal waveform in the X-axis direction presents a downward unimodal distribution, and the signal waveform in the Y-axis direction presents a down-up bimodal distribution.

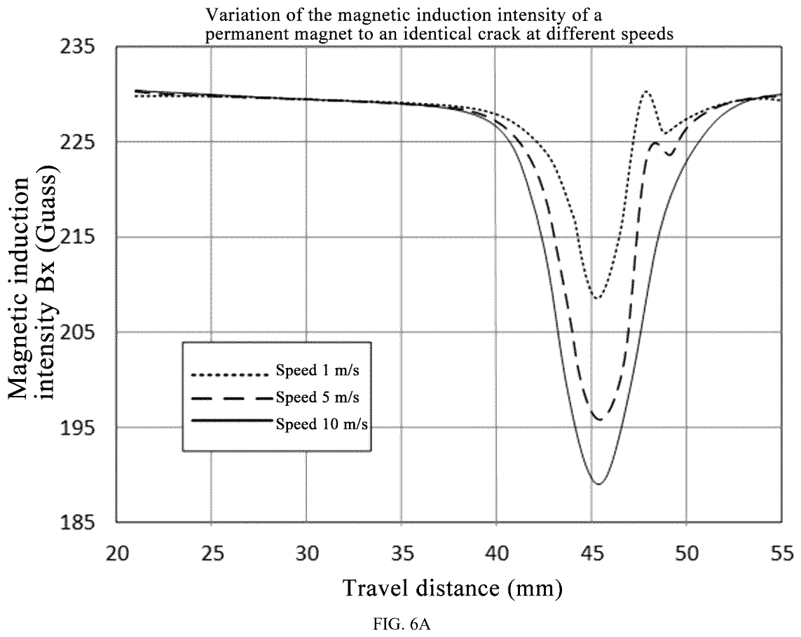

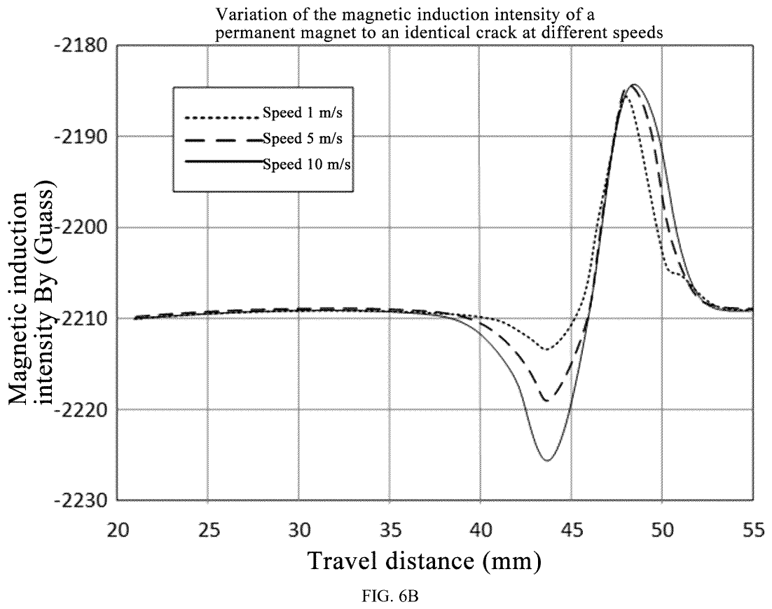

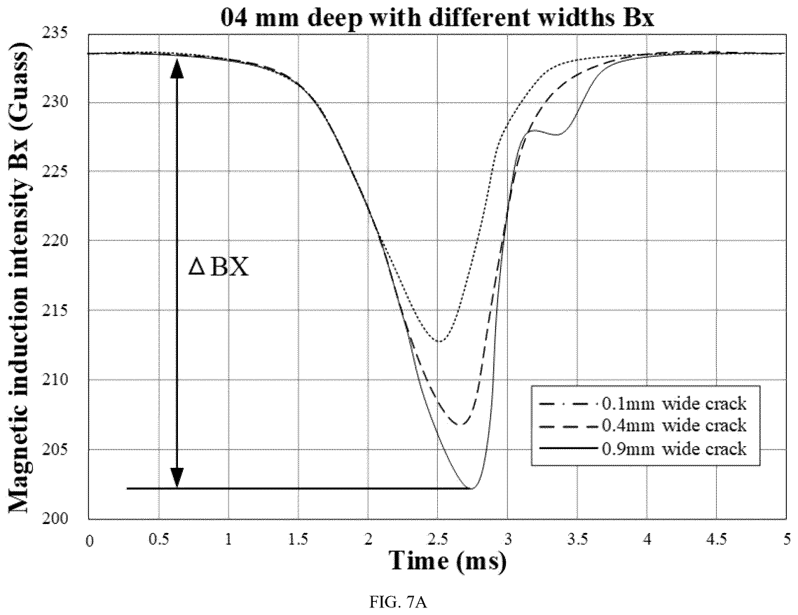

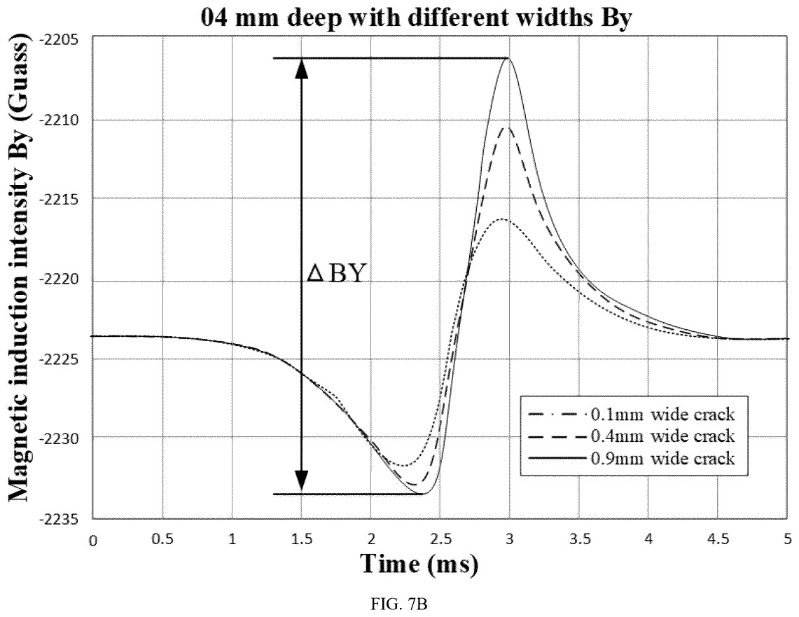

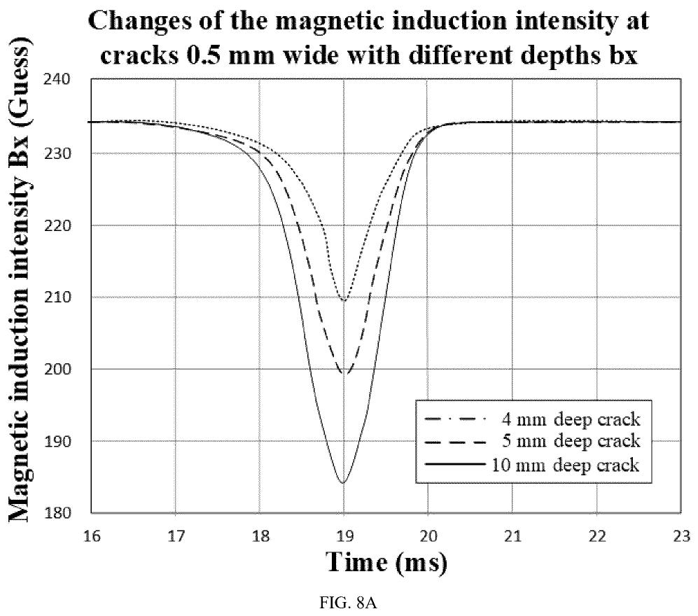

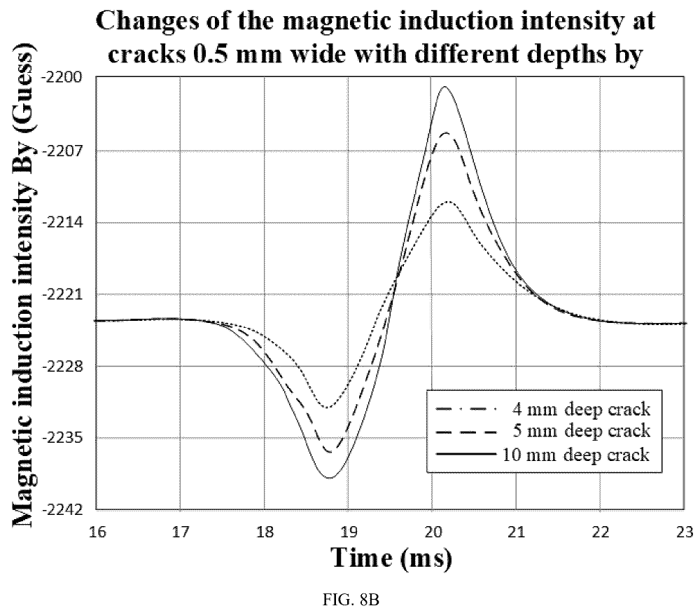

FIGS. 6A-6B schematically illustrate plots of crack detection signals at different speeds; FIGS. 7A-7B schematically illustrate plots of crack detection signals with different widths; and FIGS. 8A-8B schematically illustrate plots of crack detection signals with different depths, according to embodiments of the present application. In embodiments of the present application, crack defects are detected and quantified using a combination of PMP data and MIEC data collected as the probe passes over the crack. As shown in FIGS. 6A-6B, it is the signals of the sensor detecting the crack with width of 1 mm and depth of 4 mm at the speeds of 1 m/s, 5 m/s and 10 m/s. It can be seen from the figure that the probe has a good detection effect on the crack signal at different speeds, and when the movement speed varies within the range of 1 m/s-10 m/s, the movement speed of the probe has a significant effect on the signals in the X-axis direction and the Y-axis direction. It can also be seen that as the movement speed increases, the earlier the magnetic induction intensity in the x direction and y direction changes, i.e., the earlier the crack is felt, and the signal begins to change from the baseline value, showing the effect of the drag effect of the MIEC on the detection signal, and when the movement speed varies within the range of 1 m/s-10 m/s, the faster the movement speed, the better the effect of crack detection, and the composite dynamic crack detection probe has a significant advantage over the existing probe of in-line detection for magnetic flux leakage, i.e., crack signals can be detected at high speeds of movement.

As shown in FIGS. 7A-7B, when the movement speed of the composite dynamic crack detection probe is 5 m/s, it can be seen that the crack width has an influence on the amplitude change of magnetic induction intensity in x and y directions for the crack defect detection signals with a depth of 20% of the pipe wall thickness and widths of 0.1 mm, 0.4 mm and 0.9 mm, respectively. In order to study the influence degree of crack width on the amplitude of magnetic induction intensity, ΔBx and ΔBy are specially defined. Where, ΔBx is the difference between the signal valley and the baseline value, and ΔBy is the difference between the positive peak value and the negative peak value of the signal. It can be seen from the figure that both ΔBx and ΔBy have a linear relationship with the crack width. In addition, the crack width shows a linear relationship with the arrival time of the signal valley in the X-axis direction.

As shown in FIGS. 8A-8B, when the movement speed of the composite dynamic crack detection probe is 5 m/s, for the crack defect detection signals with a crack width of 0.5 mm and depths of 20% of the pipe wall thickness, 30% of the pipe wall thickness and 50% of the pipe wall thickness, it can be seen that the crack depth has obvious influence on the amplitude change of magnetic induction intensity in x and y directions, but has little influence on the peak arrival time, so ΔBx and ΔBy are specially defined. Where, ΔBx is the difference between the signal valley and the baseline value, and ΔBy is the difference between the positive peak value and the negative peak value of the signal. It can be seen from the figure that both ΔBx and ΔBy have a linear relationship with the crack depth.

In embodiments of this application, the crack width in the pipe wall has an influence on the amplitude and peak arrival of the magnetic induction intensity signal, while the crack depth in the pipe wall has an influence on the amplitude of the magnetic induction intensity signal. Therefore, in embodiments of the present application, the peak arrival time is used to characterize the width of the crack and the amplitude of the signal is used to characterize the depth of the crack.

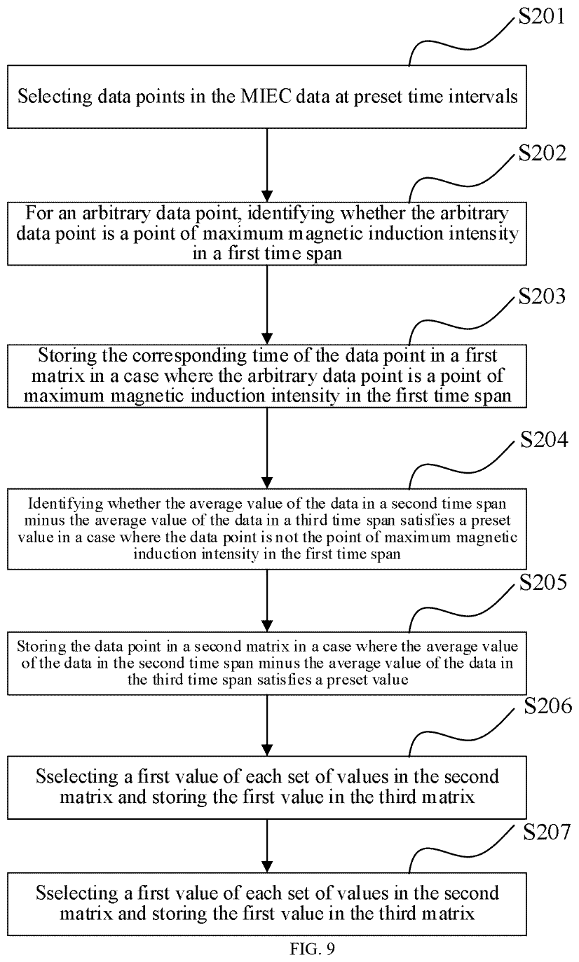

FIG. 9 schematically illustrates a flowchart determining characteristic data of a crack according to embodiments of the present application. As shown in FIG. 9, in embodiments of the present application, determining characteristic data of a crack based on the MIEC data may include:
S201, selecting data points in the MIEC data at preset time intervals;
S202, for an arbitrary data point, identify whether the arbitrary data point is a point of maximum magnetic induction intensity in a first time span;
S203, storing the corresponding time of the data point in a first matrix in a case where the arbitrary data point is a point of maximum magnetic induction intensity in the first time span;
S204, identifying whether the average value of the data in a second time span minus the average value of the data in a third time span satisfies a preset value in a case where the data point is not the point of maximum magnetic induction intensity in the first time span;
S205, storing the data point in a second matrix in a case where the average value of the data in the second time span minus the average value of the data in the third time span satisfies a preset value;
S206, selecting a first value in each set of values in the second matrix and storing the first value in a third matrix; and
S207, subtracting the values in the first matrix from the values in the third matrix to obtain characteristic data of the crack.

In embodiments of the present application, after the controller receives the PMP data and the MIEC data sent by the probe, the characteristic data of the crack in the MIEC data, i.e., the peak arrival time in the X-axis data, is extracted. The controller first selects the data points in the MIEC data at a preset time interval starting from a first data point of a data segment, wherein the preset time interval may be set according to the actual situation. For an arbitrary data point, identify whether the arbitrary data point is a point of maximum magnetic induction intensity in a first time span, that is, 500 ms before and after the data point. Store the corresponding time of the data point in a first matrix in a case where the arbitrary data point is a point of maximum magnetic induction intensity in the first time span. Identify whether the average value of the data in a second time span, that is, from 10 ms before the data point to 30 ms after the data point, minus the average value of the data in a third time span, that is, from 20 ms before the data point to 20 ms after the data point, satisfies a preset value in a case where the data point is not the point of maximum magnetic induction intensity in the first time span. Store the data point in a second matrix in a case where the average value of the data in the second time span minus the average value of the data in the third time span satisfies a preset value, wherein the preset value is a value greater than 0.2 and less than 0.3. Select a first value in each set of values in the second matrix and store the first value in a third matrix. Subtract the values in the first matrix from the values in the third matrix to obtain characteristic data of the crack, i.e. the peak arrival time.

In one example, the controller looks for the point of the peak arrival time. The controller first determines whether the first data point is the maximum point within 500 ms before and after, if so, the point is considered to be the peak position, and the time corresponding to this data point is recorded and stored in a matrix A. If not, again identify whether the average value of the data in the time span from 10 ms before the point to 30 ms after the point minus the average value of the data in the time span from 20 ms before the point to 20 ms after the point is greater than 0.2 and less than 0.3. If yes, the point is considered to be in the state of fluctuating from smooth to upward, and the time corresponding to that data point is stored in matrix B. Sequentially find the data points in a segment of MIEC data at 1 ms intervals and store the data points in matrix A and matrix B, respectively. There are several sets of data values in matrix B. Find the first value in each set, which is considered to be the starting position of the segment of data that enters the cracked region resulting in a peak in the data, and store it in matrix C. Finally, subtracting matrix C from matrix A is the time difference in reaching the peak position from the normal state. Because a segment of data may have multiple peaks, the number of peaks is equal to the number of cracks, so they are stored in a matrix.

A method for dynamic crack detection in an embodiment of the present disclosure includes the steps of:
S1001, receiving PMP data and MIEC data of an inner surface of a pipe collected by a probe;
S1002, determining the PMP data and the MIEC data as data of a crack in a case where the PMP data and the MIEC data conform to characteristics of a crack defect signal; and
S1003, determining characteristic data of the crack based on the MIEC data.

Alternatively, in the above technical solution, determining the PMP data and the MIEC data as data of a crack in a case where the PMP data and the MIEC data conform to characteristics of a crack defect signal includes:

determining that the PMP data and the MIEC data are data at a crack in a case where the waveform in the X-axis direction of the PMP data presents an upward unimodal distribution, the waveform in the Y-axis direction presents an up-down bimodal distribution, the waveform in the X-axis direction of the MIEC data presents a downward unimodal distribution, and the waveform in the Y-axis direction presents a down-up bimodal distribution. See the above description on FIG. 4, which will not be repeated here.

Alternatively, in the above technical solution, determining the characteristic data of the crack based on the MIEC data includes:
S10001, identifying whether the current data point chosen from the MIEC data is a point with the maximum magnetic induction intensity in a first time span to obtain a first identification result; if the first identification result is yes, storing the moment corresponding to the current data point in a first array; if the first identification result is no, proceeding to S10002, wherein the first time span refers to: a continuous time span including the moment corresponding to the current data point;
S10002, identifying whether the difference between the average value of the data in a second time span and the average value of the data in a third time span is less than a preset value to obtain a second identification result; if the second identification result is yes, storing the moment corresponding to the current data point in a second array, selecting a next data point as the current data point from the MIEC data according to preset conditions, and returning to S10001; if the second identification result is no, selecting a next data point as the current data point from the MIEC data according to preset conditions, wherein the second time span refers to: a continuous time span including the moment corresponding to the current data point and the third time span refers to: a continuous time span including the moment corresponding to the current data point, the lengths of the first time span, the second time span, and the third time span are different and the first time span completely covers the second time span and the third time span;
wherein, the preset value is: the difference between the maximum value and the minimum value of the noise of a segment of normal signals on the pipe without defects, for example, the preset value is 0.3, and the preset value can also be set according to the actual situation;
S10003, when the second identification result is yes for a number of consecutive occurrences, storing the moment corresponding to the first time the second identification result is yes in a third array, selecting a next data point as the current data point from the MIEC data according to preset conditions, and returning to S10001; and
S10004, calculating the length of time between moments at the same position in the first array and the third array to obtain characteristic data of the crack.

Taking FIG. 8A as an example, the first time span may be specifically 10 ms: the first 5 ms and the last continuous time spans including the moment corresponding to the current data point. Through the above S10001, it is possible to determine a point with the maximum magnetic induction intensity in the first time span, i.e., an extreme point, that is, a data point corresponding to 19 ms in FIG. 8A, at this time, the 19 ms is stored in the first array;
where the first time span and the second time span may both be set to 4 ms: the second time span is specifically the first 2 ms and the second continuous time span including the moment corresponding to the current data point, and the third time span is specifically the first 1 ms and the third continuous time span including the moment corresponding to the current data point. Then, the inflection point can be determined through S10002˜S10003, for example, the 16.5 ms in FIG. 8A will be stored in a third array. At this time, the first moment in the first array is 19 ms, and the first moment in the third array is 16.5 ms. The time difference between these two moments is 2.5 ms, and the characteristic data of the crack, that is, the peak arrival time, can be obtained as 2.5 ms.

The purpose of S10003 is to find the time at which the peaks of all the cracks in the MIEC data arrive, the number of moments saved in the first array and the third array is the same, and the moment in the same position means: the moment at which the nth moment in the first array is in the same position as the nth moment in the third array, and n is a positive integer, wherein the selection of the next data point from the MIEC data in accordance with the preset conditions may be specified as: selecting the data point in the MIEC data at a preset time interval, or, selecting the data point in the MIEC data at a preset number of intervals.

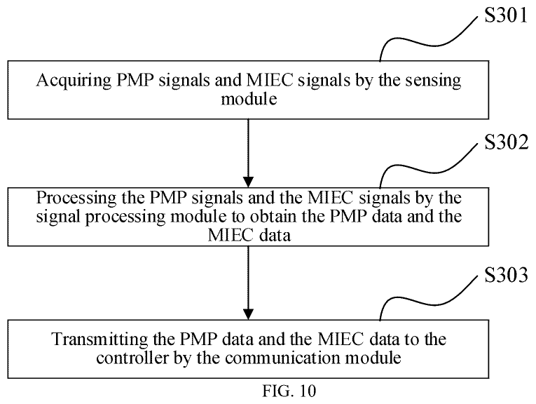

FIG. 10 schematically illustrates a flowchart of a method for data acquisition according to embodiments of the present application. As shown in FIG. 10, the embodiments of the present application provide a method for data acquisition. The method is applied to a probe, and the probe communicates with a controller, including a sensing module, a signal processing module, and a communication module. The signal processing module is connected to the sensing module, and the communication module is connected to the signal processing module, and the method may include:
S301, acquiring PMP signals and MIEC signals by the sensing module;
S302, processing the PMP signals and the MIEC signals by the signal processing module to obtain the PMP data and the MIEC data; and
S303, transmitting the PMP data and the MIEC data to the controller by the communication module.

In embodiments of the present application, the sensing module first acquires the PMP signals and the MIEC signals, and then processes the PMP signals and the MIEC signals through the signal processing module to obtain the PMP data and the MIEC data. Finally, the communication module transmits the PMP data and the MIEC data to the controller. Specifically, the magnetic perturbation sensor and the tri-axis Hall sensor simultaneously collect the PMP signals and the MIEC signals. The PMP signals and the MIEC signals are sequentially amplified, filtered, and analog-to-digital converted in turn, and uploaded to a main controller by the communication module.

In embodiments of the present application, the sensing module includes a permanent magnet, a magnetic perturbation sensor, and a tri-axis Hall sensor. The magnetic perturbation sensor is provided on a first side of the permanent magnet, and the tri-axis Hall sensor is provided on a second side of the permanent magnet, and the method may include:
forming a magnetic perturbation environment and generating eddy current signals by the permanent magnet;
collecting PMP signals by the magnetic perturbation sensor; and
collecting MIEC signals by the tri-axis Hall sensor.

In embodiments of the present application, the sensing module includes three parts: a permanent magnet, a magnetic perturbation sensor, and a tri-axis Hall sensor. The magnetic perturbation sensor is located on a first side of the permanent magnet, for collecting and measuring the magnetic perturbation signal changes generated by the movement of the permanent magnet relative to the pipe. When the permanent magnet is placed close to the surface of the pipe, magnetic interaction occurs, creating a magnetic perturbation environment, and crack defects on the inner surface of the pipe act as a source of perturbation, which then forms a magnetic perturbation and is observed. The tri-axis Hall sensor is located on a second side of the permanent magnet, and the permanent magnet moves relative to the pipe wall during the detection process to generate eddy current signals, and the eddy current signals generate abnormal signals at the cracks on the inner surface of the pipe, and the tri-axis Hall sensor is used to measure the abnormal signals generated by the MIEC at the cracks in the inner wall of the pipe, i.e., the MIEC signals, wherein a first side of the permanent magnet is below the permanent magnet and a second side of the permanent magnet is behind the permanent magnet.

In embodiments of the present application, the signal processing module includes an amplifier, a filter and an analog/digital signal converter. The amplifier is connected to a magnetic perturbation sensor and a tri-axis Hall sensor, the filter is connected to the amplifier, the analog/digital signal converter is connected to the filter, and the method may include:
amplifying the PMP signals and the MIEC signals by the amplifier;
filtering high-frequency noise in the amplified PMP signals and the MIEC signals by the filter; and
converting the denoised PMP signals and the MIEC signals from analog signals to digital signals by the analog/digital signal converter.

In embodiments of the present application, the signal processing module includes an amplifier, a filter, and an analog/digital signal converter, and the amplifier is connected to the magnetic perturbation sensor and the tri-axis Hall sensor, accepting the PMP signals detected by the magnetic perturbation sensor and the MIEC signals detected by the tri-axis Hall sensor. The amplifier filters out the spurious signals from the voltage signals and amplifies the signals by a certain multiple, and the amplified signals are more conducive to reading and processing later signals. The filter is connected to the amplifier to receive the detection signal amplified by the amplifier, and the filter is a low-pass filter provided between the amplifier and the analog/digital signal converter for performing a filtering operation on the amplified detection signal, filtering out high-frequency noise in the detection signal, and then transmitting the detection signal with the high-frequency noise eliminated to the analog/digital signal converter. The analog/digital signal converter is connected to the filter to receive the filtered detection signal, and the analog/digital signal converter converts the denoised analog signals to digital signals and outputs the digital signals after conversion as a result.

The embodiments of the present application also provide a machine-readable storage medium having instructions stored thereon, the instructions being used to cause the machine to perform the method for controlling a boom described above.

Those skilled in the art shall understand that the embodiments of the present application may be provided as a method, a system or a computer program product. Therefore, the present application may be in the form of complete hardware embodiments, complete software embodiments, or software-hardware combined embodiments. Furthermore, the present application may take the form of a computer program product implemented on one or more computer-usable storage media (including but not limited to disk memory, CD-ROM, optical memory, etc.) including computer-usable program codes.

The present application is described with reference to flowcharts and/or block diagrams of the method, the device (system), and the computer program product according to the embodiments of the present application. It should be understood that, each flow and/or block in the flowcharts and/or block diagrams, as well as the combination of flow and/or block in the flowcharts and/or block diagrams can be implemented by computer program instructions. The computer program instructions may be provided to general-purpose computers, special-purpose computers, embedded processors or processors of other programmable data processing devices to produce a machine, so that a device for realizing the functions specified in one or multiple flows in the flowchart and/or one or multiple blocks in the block diagram is generated by the instructions to be executed by computers or processors of other programmable data processing devices.

The computer program instructions may also be stored in a computer-readable memory capable of directing a computer or other programmable data processing devices to operate in a particular manner, so that the instructions stored in the computer-readable memory produce an article of manufacture including a command device, and the command device implements the functions specified in one or multiple flows in the flowchart and/or one or multiple blocks in the block diagram.

The computer program instructions may also be loaded onto a computer or other programmable data processing devices such that a series of operational steps are performed on the computer or other programmable devices to produce a computer-implemented process, whereby the instructions executed on the computer or other programmable devices provide steps for implementing the functions specified in one or multiple flows in the flowchart and/or one or multiple blocks in the block diagram.

In a typical configuration, the computing device includes one or more central processing units (CPUs), input/output interfaces, network interfaces and memory.

A memory may include non-permanent memory in a computer-readable medium, random access memory (RAM), and/or non-volatile memory such as read only memory (ROM) or flash RAM. The memory is an example of the computer-readable medium.

A computer-readable medium, either permanent or non-permanent, removable or non-removable, may be implemented with information storage by any method or technique. Information may be computer-readable instructions, data structures, modules of a program, or other data. Examples of the computer storage medium include, but are not limited to, Phase-change Random Access Memory (PRAM), Static Random Access Memory (SRAM), Dynamic Random Access Memory (DRAM), other types of random access memory (RAM), Read Only Memory (ROM), Electrically Erasable Programmable Read-Only Memory (EEPROM), flash memory or other memory technologies, Compact Disc-Read Only Memory (CD-ROM), Digital Versatile Disc (DVD) or other optical memory, magnetic cassette tape, magnetic tape disk memory or other magnetic memory device or any other non-transport medium that may be used to store information accessible by a computing device. As defined herein, a computer-readable medium does not include transitory computer-readable media, such as modulated data signals and carriers.

It should also be noted that the terms “including”, “including”, or any other variant thereof, are intended to cover non-exclusive inclusion, so that a process, method, commodity or equipment including a set of elements includes not only those elements but also other elements that are not expressly listed or that are inherent to such process, method, commodity or equipment. Without further limitation, the fact that an element is defined by the phrase “including a . . . ” does not preclude the existence of another identical element in the process, method, commodity, or equipment in which the element is included.

The above are only examples of embodiments of the present application and are not intended to limit the present application. Various changes and variations of the present application are possible for those skilled in the art. Any modifications, equivalent substitutions, improvements, etc., made within the spirit and principles of the present application shall be included within the scope of the claims of the present application.

What is claimed is:

1. A device for dynamic crack detection, comprising a probe and a controller; wherein
the probe is configured to acquire permanent magnetic perturbation (PMP) data and motion-induced eddy current (MIEC) data of an inner surface of a pipe; and
the controller is in communication with the probe, and configured to:
receive the PMP data and the MIEC data from the probe;
determine the PMP data and the MIEC data as data of a crack when the PMP data and the MIEC data conform to characteristics of a crack defect signal; and
determine characteristic data of the crack based on the MIEC data.

2. The device for dynamic crack detection according to claim 1, wherein the probe comprises a sensing module, a signal processing module and a communication module;
the sensing module is configured to acquire PMP signals and MIEC signals;
the signal processing module is connected to the sensing module and configured to process the PMP signals and the MIEC signals to obtain the PMP data and the MIEC data; and
the communication module is connected to the signal processing module and configured to transmit the PMP data and the MIEC data to the controller.

3. The device for dynamic crack detection according to claim 2, wherein the sensing module comprises a permanent magnet, a magnetic perturbation sensor and a tri-axis Hall sensor, wherein
the permanent magnet is configured to form a magnetic perturbation environment and generate eddy current signals; and
the magnetic perturbation sensor and the tri-axis Hall sensor are provided on two sides of the permanent magnet, respectively, the magnetic perturbation sensor is configured to acquire the PMP signals, and the tri-axis Hall sensor is configured to acquire the MIEC signals.

4. The device for dynamic crack detection according to claim 3, wherein the signal processing module comprises an amplifier, a filter and an analog/digital signal converter;
the amplifier is connected to the magnetic perturbation sensor and the tri-axis Hall sensor, and configured to amplify the PMP signals and the MIEC signals to obtain amplified PMP signals and amplified MIEC signals;
the filter is connected to the amplifier, and configured to filter out high frequency noise from the amplified PMP signals and the amplified MIEC signals to obtain denoised PMP signals and denoised MIEC signals; and
the analog/digital signal converter is connected to the filter, and configured to convert the denoised PMP signals and the denoised MIEC signals from analog signals to digital signals.

5. The device for dynamic crack detection according to claim 1, wherein the controller is further configured to:
determine that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

6. The device for dynamic crack detection according to claim 1, wherein the controller is further configured to:
select data points in the MIEC data at preset time intervals;
for an arbitrary data point, identify whether the arbitrary data point is a point of maximum magnetic induction intensity in a first time span;
store the corresponding time of the data point in a first matrix when the arbitrary data point is the point of maximum magnetic induction intensity in the first time span;
identify whether an average value of data in a second time span minus an average value of data in a third time span satisfies a preset value when the data point is not the point of maximum magnetic induction intensity in the first time span;
store the data point in a second matrix when the average value of the data in the second time span minus the average value of the data in the third time span satisfies the preset value;
select a first value in each set of values in the second matrix and store the first value in a third matrix; and
subtract values in the first matrix from values in the third matrix to obtain the characteristic data of the crack.

7. A method for dynamic crack detection, wherein the method is applied to a controller, the controller is in communication with a probe, and the method comprises:
receiving PMP data and MIEC data from the probe;
determining the PMP data and the MIEC data as data of a crack when the PMP data and the MIEC data conform to characteristics of a crack defect signal; and
determining characteristic data of the crack based on the MIEC data.

8. The method for dynamic crack detection according to claim 7, wherein the step of determining the PMP data and the MIEC data as the data of the crack when the PMP data and the MIEC data conform to the characteristics of the crack defect signal comprises:
determining that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

9. The method for dynamic crack detection according to claim 7, wherein the step of determining the characteristic data of the crack based on the MIEC data comprises:
selecting data points in the MIEC data at preset time intervals;
for an arbitrary data point, identifying whether the arbitrary data point is a point of maximum magnetic induction intensity in a first time span;
storing the corresponding time of the data point in a first matrix when the arbitrary data point is the point of maximum magnetic induction intensity in the first time span;
identifying whether an average value of data in a second time span minus an average value of data in a third time span satisfies a preset value when the data point is not the point of maximum magnetic induction intensity in the first time span;
storing the data point in a second matrix when the average value of the data in the second time span minus the average value of the data in the third time span satisfies the preset value;
selecting a first value in each set of values in the second matrix and storing the first value in a third matrix; and
subtracting values in the first matrix from values in the third matrix to obtain the characteristic data of the crack.

10. A method for dynamic crack detection, comprising:
receiving PMP data and MIEC data of an inner surface of a pipe, wherein the PMP data and the MIEC data are collected by a probe;
determining the PMP data and the MIEC data as data of a crack when the PMP data and the MIEC data conform to characteristics of a crack defect signal; and
determining characteristic data of the crack based on the MIEC data.

11. The method for dynamic crack detection according to claim 10, wherein the step of determining the PMP data and the MIEC data as the data of the crack when the PMP data and the MIEC data conform to the characteristics of the crack defect signal comprises:
determining that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

12. The method for dynamic crack detection according to claim 10, wherein the step of determining the characteristic data of the crack based on the MIEC data comprises:
S10001, identifying whether a current data point chosen from the MIEC data is a point with an maximum magnetic induction intensity in a first time span to obtain a first identification result; when the first identification result is yes, storing a moment corresponding to the current data point in a first array; when the first identification result is no, proceeding to S10002, wherein the first time span refers to a first continuous time span including the moment corresponding to the current data point;
S10002, identifying whether a difference between an average value of data in a second time span and an average value of data in a third time span is less than a preset value to obtain a second identification result; when the second identification result is yes, storing the moment corresponding to the current data point in a second array, selecting a next data point as the current data point from the MIEC data according to preset conditions, and returning to S10001; when the second identification result is no, selecting a next data point as the current data point from the MIEC data according to the preset conditions, wherein the second time span refers to a second continuous time span including the moment corresponding to the current data point, and the third time span refers to a third continuous time span including the moment corresponding to the current data point, a length of the first time span, a length of the second time span and a length of the third time span are different, and the first time span completely covers the second time span and the third time span;
S10003, when the second identification result is yes for a number of consecutive occurrences, storing a moment corresponding to a first time when the second identification result is yes in a third array, selecting a next data point as the current data point from the MIEC data according to the preset conditions, and returning to S10001; and
S10004, calculating a length of time between moments at a same position in the first array and the third array to obtain the characteristic data of the crack.

13. A method for data acquisition, wherein the method is applied to a probe; the probe is in communication with a controller, and the probe comprises a sensing module, a signal processing module and a communication module; the signal processing module is connected to the sensing module, and the communication module is connected to the signal processing module;
wherein the method comprises:
acquiring PMP signals and MIEC signals by the sensing module;
processing the PMP signals and the MIEC signals by the signal processing module to obtain the PMP data and the MIEC data; and
transmitting the PMP data and the MIEC data to the controller by the communication module.

14. The method for data acquisition according to claim 13, wherein the sensing module comprises a permanent magnet, a magnetic perturbation sensor and a tri-axis Hall sensor; the magnetic perturbation sensor is set on a first side of the permanent magnet, and the tri-axis Hall sensor is set on a second side of the permanent magnet;
the method further comprises:
forming a magnetic perturbation environment and generating eddy current signals by the permanent magnet;
collecting the PMP signals by the magnetic perturbation sensor; and
collecting the MIEC signals by the tri-axis Hall sensor.

15. The method for data acquisition according to claim 14, wherein the signal processing module comprises an amplifier, a filter, and an analog/digital signal converter; the amplifier is connected to the magnetic perturbation sensor and the tri-axis Hall sensor, the filter is connected to the amplifier, and the analog/digital signal converter is connected to the filter;
the method further comprises:
amplifying the PMP signals and the MIEC signals by the amplifier to obtain amplified PMP signals and amplified MIEC signals;
filtering high-frequency noise in the amplified PMP signals and the amplified MIEC signals by the filter to obtain denoised PMP signals and denoised MIEC signals; and
converting the denoised PMP signals and the denoised MIEC signals from analog signals to digital signals by the analog/digital signal converter.

16. The device for dynamic crack detection according to claim 2, wherein the controller is further configured to:
determine that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

17. The device for dynamic crack detection according to claim 3, wherein the controller is further configured to:
determine that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

18. The device for dynamic crack detection according to claim 4, wherein the controller is further configured to:
determine that the PMP data and the MIEC data are the data at the crack when a waveform in an X-axis direction of the PMP data presents an upward unimodal distribution, a waveform in a Y-axis direction of the PMP data presents an up-down bimodal distribution, a waveform in the X-axis direction of the MIEC data presents a downward unimodal distribution, and a waveform in the Y-axis direction of the MIEC data presents a down-up bimodal distribution.

19. The device for dynamic crack detection according to claim 2, wherein the controller is further configured to:
select data points in the MIEC data at preset time intervals;
for an arbitrary data point, identify whether the arbitrary data point is a point of maximum magnetic induction intensity in a first time span;
store the corresponding time of the data point in a first matrix when the arbitrary data point is the point of maximum magnetic induction intensity in the first time span;
identify whether an average value of data in a second time span minus an average value of data in a third time span satisfies a preset value when the data point is not the point of maximum magnetic induction intensity in the first time span;
store the data point in a second matrix when the average value of the data in the second time span minus the average value of the data in the third time span satisfies the preset value;
select a first value in each set of values in the second matrix and store the first value in a third matrix; and
subtract values in the first matrix from values in the third matrix to obtain the characteristic data of the crack.

20. The device for dynamic crack detection according to claim 3, wherein the controller is further configured to:
select data points in the MIEC data at preset time intervals;
for an arbitrary data point, identify whether the arbitrary data point is a point of maximum magnetic induction intensity in a first time span;
store the corresponding time of the data point in a first matrix when the arbitrary data point is the point of maximum magnetic induction intensity in the first time span;
identify whether an average value of data in a second time span minus an average value of data in a third time span satisfies a preset value when the data point is not the point of maximum magnetic induction intensity in the first time span;
store the data point in a second matrix when the average value of the data in the second time span minus the average value of the data in the third time span satisfies the preset value;
select a first value in each set of values in the second matrix and store the first value in a third matrix; and
subtract values in the first matrix from values in the third matrix to obtain the characteristic data of the crack.
